(19) United States
(12) Patent Application Publication
(10) Pub. No.: US 2007/0043510 A1
(43) Pub. Date: Feb. 22, 2007

(54) Assay system

(75) Inventors: David L. Yang, Orange, CA (US); Paul H. Kraght, San Dimas, CA (US)

Correspondence Address: BECKMAN COULTER INC.;C/O SHELDON MAK ROSE & ANDERSON, 225 SOUTH LAKE AVENUE, 9TH FLOOR, PASADENA, CA, 91101, US

(73) Assignee: Beckman Coulter, Inc.

(21) Appl. No.: 11/208,145

(22) Filed: Aug. 19, 2005

(51) Int. Cl. G06F 19/00

(52) U.S. Cl. 702/19; 702/20

(57) ABSTRACT

Different targets in a sample are assayed utilizing a control substrate and different sets of detector substrates, each set being adapted to capture a particular target. The substrates contain identifiers such as fluorescent dyes, which generate signals in a detection step. To minimize false negatives and false positives and misidentification of detector substrates, expected signals from the substrates are calculated based on the signals from the control substrate, and this data is utilized to determine what targets are present in a sample.

### BACKGROUND

Systems using substrates labeled with different types and quantities of fluorescent dyes for detecting multiple different targets in a sample are known. During a detection step, the fluorescent dyes generate different detectable signals to differentiate between various substrates. Each different type of substrate, often a particle or bead, is adapted for capturing different targets in a sample, thus allowing multiple different targets in a sample to be detected simultaneously.

A problem associated with such systems is difficulty in determining which signals from the fluorescent dyes are associated with particular beads, thus resulting in some false positives and false negatives for targets. Inaccuracies also can result from variations experienced with different instruments. The amount of inaccuracy can increase as the number of different types of beads used increases, making it difficult to associate signals with particular beads. Also, spurious signals can result from broken down beads and other debris.

Accordingly, there is a need for a dependable and accurate system for simultaneously detecting multiple targets in a sample, where the number of false positives and false negatives and misidentification of detector substrates is reduced.

### SUMMARY

The present invention provides a detection system for detecting multiple different targets in a sample that satisfies this need. The detection system comprises at least two detector substrates (i.e., first and second detector substrates) and at least one control substrate. The substrates typically are bead sets. Each substrate has at least one identifier, typically fluorescent labels, associated therewith. The identifiers are capable of producing detectable signals, where the detectable signals for each detector substrate and control substrate are different. Preferably, each detector and control substrate has first and second identifiers associated therewith, the first and second identifiers being capable of producing a set of first and second detectable signals for each detector and control substrate, respectively, wherein the first and second detectable signals are different, and the intensity of the set of first and second detectable signals from each detector substrate and control substrate differ from each other. More preferably, the identifiers are cyanine dyes that produce a detectable signal in the near infrared.

The first detector substrate is capable of capturing a first selected target in the sample, and the second detector substrate likewise is capable of capturing a second selected target in the sample, wherein the first and second selected targets are different. Preferably, the target will have a detection dye associated therewith, where the detection dye is capable of producing a detectable signal.

In one embodiment, the control substrate is substantially incapable of capturing any target present in the sample. In another embodiments the control substrate is the same type of substrate as one of the detector substrates.

The detection system is “normalized” by causing the detector substrates and the control substrate to produce detectable signals and computing the relative ratio of the signal intensities obtained from the detector substrates to the signal intensities obtained from the control substrates.

In an assay, a sample is contacted with the detector substrates for capturing targets in the sample. Next, the detector substrates and the control substrates are caused to produce detectable signals, and the intensity of the produced signals is determined. Substrates that have captured their specific target and have a detection dye associated therewith can also generate an analytical detection signal such as a fluorescent emission. The substrates are identified at least partly by a unique combination of identifiers incorporated therein. According to this invention, expected detectable signals for each set of the detector substrates are ascertained based on the determined intensity of the signals from the control substrate utilizing the normalized data. The expected detectable signals can be computed utilizing the control substrate from a lookup table or the like, which provides the “normalized” data for the detection system being used. The produced intensities of the detector substrates are then compared with the expected detectable signal intensities to associate at least some of the produced detectable signals with respective detector substrates.

The present invention also provides a kit for assaying multiple targets in a sample. The kit comprises the detection system and media, such as a computer disc or printed sheet, containing the normalized data for each set of the detector substrates. The kit can also include instructions for performing the assay.

### DRAWINGS

These and other features, aspects, and advantages of the present invention will become better understood from the following description, appended claims and accompanying drawings where:

FIGS. 1A and 1B illustrate exemplary particles for use in a multi-target particle based assay according to the present invention where target 1 illustrates a particle-receptor-target-receptor complex, and particle 2 illustrates a particle-receptor-target complex;

FIG. 2 is a schematic illustration of an exemplary flow cytometry system in accord with the present invention;

FIG. 3 is a flow chart of a method practiced using a particle detection system as exemplified in FIG. 1 and incorporating the present invention;

FIG. 4 presents measured intensities from an assay conducted with 12 bead populations (11 detector substrates and a control substrate), run on three different cytometers, without normalization; and

FIG. 5 presents the same results shown in FIG. 4 with normalization according to the present invention.

### DESCRIPTION

The present invention is directed to improvement for assays conducted for detecting multiple different targets in a sample. The invention improves existing assays by automatically associating encoded (i.e., labeled) substrates, such as bead populations, with their target analyte by assigning a “relative ratio” factor to each substrate.

In this invention, a detection system is used, the detection system comprising at least two detector substrates and at least one control substrate. Each detector substrate and control substrate has one or more identifiers, such as a fluorescent label, which produces a different detectable signal for each detector substrate and each control substrate. “Different” detectable signals means that the signals are spectroscopically distinguishable from each other. For example, in case of a pair of fluorescent dye identifiers, the wavelengths of the first and second identifiers will be spectroscopically distinguishable (e.g., the first and second detectable signals will have an emission maxima of at least about 10 nm apart), and the intensity of the first and second identifiers from each detector substrate differs from each other for at least one of the identifiers. Alternately, the identifiers may be of different size and can be distinguished based on different scatter intensities.

Two types of substrates are used in the detection system, detector substrates and control substrates. The term “detection” includes both quantitative and qualitative analysis of a target. The term “target” refers to any substance whose presence, activity and/or amount is desired to be determined. A sample containing a target can be any type of fluid, such as a liquid, to be assayed. The sample can be such fluids as blood, serum, urine, spinal fluid, tears and the like.

In one embodiment, the control substrate and the detector substrates are different and the control substrate is substantially incapable of capturing any target present in the sample. According to this embodiment, when used in an assay, the control substrate can be analyzed separately (with or without sample), or in the same assay (with sample) as the detector substrates. In another embodiment, the control substrate can be the same as one of detector substrates (i.e., the control substrate is also a detector substrate). According to this embodiment, when used in an assay, the control substrate can be assayed with the other detector substrates, or analyzed separately (in the absence of sample) from the detector substrates.

Targets can be man-made or naturally-occurring substances. They can be employed in their unaltered state or as aggregates with other species such as antibodies and signal generators such as fluorophores. Targets can be attached, covalently or noncovalently, to a binding member, either directly or via a specific binding substance. Examples of targets for which this invention can be employed, but are not limited to, receptors (on vesicles, lipids, cell membranes or a variety of other receptors); small metabolite molecules, e.g. saccharides such as glucose, fructose, lactose or galactose; ammonia, urea, uric acid, cholesterol, acetaminophen, bilirubin and creatinine, ligands, agonists or antagonists which bind to specific receptors; polyclonal antibodies, monoclonal antibodies and antisera reactive with specific antigenic determinants (such as on viruses, cells or other materials); drugs; nucleic acids or polynucleotides (including mRNA, tRNA, rRNA, oligonucleotides, DNA, viral RNA or DNA, ESTs, cDNA, PCR-amplified products derived from RNA or DNA, and mutations, variants or modifications thereof); proteins (including enzymes, such as those responsible for cleaving neurotransmitters, proteases, kinases and the like); substrates for enzymes; peptides; cofactors; lectins; sugars; polysaccharides; cells (which can include cell surface antigens); cellular membranes; organelles; as well as other such molecules or other substances which can exist in complexed, covalently bonded or crosslinked states. As used herein, the terms nucleic acid, polynucleotide, polynucleic acid and oligonucleotide are interchangeable. Targets can also be referred to as analytes.

The detector substrates are capable of capturing specific targets in a sample. For example, the detector substrate can be a bead, also referred to as a “particle” that is tailored to qualitatively or quantitatively detect specific targets. Techniques for adapting substrates for capturing particular targets are described in U.S. Patent Publication Nos. 2003/0092008; 2003/0092062; and 2004/0209261, which are incorporated herein by reference. An example of a suitable preparation technique is described in U.S. Pat. No. 4,609,689, incorporated herein by reference. Alternatively, the beads/particles can be obtained from a commercial supplier such as Bio-Rad Laboratories Inc. (Hercules, Calif.), or Bangs Laboratories Inc. (Fishers, Ind.).

Typically, the detector and control substrates are particles such as beads. The beads can be substantially the same size and configuration, but need not be of the same size. Beads for cytometry typically range in size from about 0.1 μm to about 50 μm, and more typically from about 1 μm to about 20 μm in diameter. Their density is typically from about 0.5 to about 2 grams per milliliter. However, when a control substrate is used that is different from a detector substrate in size, it is preferable that the control substrate be at least 10% larger or 10% smaller, and more preferably, at least 20% larger or 20% smaller, than the other substrates in diameter for ease in distinguishing the control substrate.

The substrates can be formed from a material such as silica, aluminum, metal, ceramic, and polymers. The substrate can be of any type that has been used in cytometry including polystyrene latex particles, acrylate or methacrylate derived particles, hydrogel polymer particles, polymerized micelle particles, particles produced by grinding cast film, particles produced by photopolymerization of aqueous emulsion, and particles produced by solvent casting as described in U.S. Pat. Nos. 4,302,166 and 4,162,284. Typically, the substrates employed in the present invention are beads generally made of a polymeric materials such as polystyrene. Suitable preparation techniques of such beads that are useful in the present invention are generally known to those skilled in the art. An example of a suitable preparation technique is described in U.S. Pat. Nos. 4,609,689, 6,599,331, and 6,632,526 incorporated herein by reference. Alternatively, the beads/particles may be obtained from a commercial supplier such as Bio-Rad Laboratories Inc. (Hercules, Calif.), or Bangs Laboratories Inc. (Fishers, Ind.).

Each detector and control substrate has coding indicia, i.e., an identifier to enable identification of the substrate type, and consequently enables the analysis system to assign measurement signals from a substrate to a specific target with which the substrate interacts. The identifiers can be a characteristic of the substrate such as size, magnetism, light intensity, and other spectroscopic properties including absorbance, light scatter, color, and fluorescence at one or more wavelengths. As used herein, a “type” of substrate, bead, or particle refers to all substrates which interact in the same way with a given target. It is, of course, possible for a reagent mixture to include two or more different types of substrates that interact with the same target in different ways.

For example, particle size or color can be used as parameters for distinguishing between subpopulations of beads/particles. Fluorescence characteristics of beads/particles can also be used in a variety of analytical systems. Fluorescent labels are desirable markers for coding beads/particles and can be used a variety of different approaches including employing single and multiple fluorescers as labels. The use of fluorescent labels as markers in flow cytometry systems is described, for example, in U.S. Pat. Nos. 4,745,285; 5,028,545; 5,682,038; and 5,880,474, all of which are incorporated herein by reference.

For multiplex analysis, it is desirable that the system be capable of analysis of multiple targets in a sample simultaneously. Accordingly, it is preferred, but not required that the substrates are coded with multiple labels to allow the system to distinguish multiple subpopulations of particles. It is also preferred, but not required that when fluorescent labels are used as the coding indicia, that separate space is reserved for the emission spectra for the analyte/target of interest.

Since this invention is directed to detecting multiple targets in a sample simultaneously, preferably, there are at least two sets of detector substrates, each set being capable of detecting a different target. Typically, there are more than 10 such sets, and there can be as many as 100 or more sets of detector substrates.

Any type of identifier commonly used in assays can be used in the present invention, including radioactive compounds, luminescent compounds, and fluorescent compounds. The identifier need not be a compound that generates a detectable signal, but can be a compound that combined with another compound generates a detectable signal. Preferred identifiers are fluorescent labels (also known as fluorescent dyes) that when interrogated by a light source such as laser light, generate detectable light. More preferably, the fluorescent dyes have absorbance and emission spectra in the near infrared (NIR) region i.e., absorbance and emission just beyond the visible region (e.g., from about 600 nm to about 1600 nm). Examples of suitable fluorescent dyes include cyanine dyes (e.g., phthalocyanines and carbocyanines) and squaraines, etc.

Suitable fluorescent dyes are generally stable, hydrophobic compounds that can be incorporated into a polymeric bead. Known fluorescent dyes can be used to label individual types of beads. Examples include those known by the designations IR792 ([2-[2-[3-[(1,3-dihydro-3,3-dimethyl-1-propyl-2H-indol-2-ylidine)ethylidine]-2-(phenylthio)-1-cyclohexen-1-yl]ethenyl]-3,3-dimethyl-1-propylindolium perchlorate]), IR768 ([2-[2-[3-[(1,3-dihydro-3,3-dimethyl-1-propyl-2H-indol-2-ylidine)ethylidine]-2-phenoxy-1-cyclohexen-1-yl] ethenyl]-3,3-dimethyl-1-propylindolium perchlorate])YL22 ([2-[2-[3-[(1,3-dihydro-3,3-dimethyl-1-propyl-2H-benzoindol-2-ylidine)ethylidine]-2-(phenylthio)-1-cyclohexen-1-yl]ethenyl]-3,3-dimethyl-1-propylbenzoindolium iodide]), IR780 ([2-[2-[2-chloro-3-[(1,3-dihydro-3,3-dimethyl-1-propyl-2H-indol-2-ylidine)ethylidine]-1-cyclohexen-1-yl]ethenyl]-3,3-dimethyl-1-propylindolium perchlorate]), JM5488-48 ([2-[2-[2-chloro-3-[(1,3-dihydro-3,3-dimethyl-1-decanyl-2H-benzoindol-2-ylidine)ethylidine]-1-cyclohexen-1-yl]ethenyl]-3,3-dimethyl-1-decanylbenzoindolium iodide]), JM5488-72 ([2-[2-[2-3-[(1,3-dihydro-3,3-dimethyl-1-decanyl-2H-benzoindol-2-ylidine)ethylidine]-1-cyclohexen-1-yl]ethenyl]-3,3-dimethyl-1-decanylbenzoindolium iodide]) IR140 and IR143 and their derivatives. Suitable fluorescent dyes are described in U.S. Pat. No. 6,838,289, incorporated herein by reference. As described therein, combinations of dyes in varying amounts or ratios can be used to provide a unique identifier for each type of substrate/particle. In addition to the identifiers used to label the substrates, another identifier, such as fluorescein, is commonly used to label captured targets.

Further examples of useful fluorescent dyes for labeling individual types of beads or for indicating complexing or reaction with an analyte of interest are known in the art. See, for example, R. P. Haugland, Handbook of Fluorescent Probes and Research Chemicals, 5th Edition, Molecular Probes Inc., Eugene, 1992; and Masaru Matsuoka, Infrared Absorbing Dyes, Plenum press, New York (1990).

In a preferred but not required embodiment, each substrate is coded with two or more identifiers, e.g., fluorescent labels. By varying the combination of different identifiers associated with each type of substrate, it is possible to distinguish different types of substrates from each other during a detection step. For example, when two different fluorescent labels are used in varying combinations as coding indicia for two types of detector substrates, a unique set of detectable signals is produced for each detector substrate. In this manner, different detector substrates and control substrates can be distinguished from each other. For example, a substrate containing one part identifier A and two parts identifier B is distinguishable from a second substrate containing two parts identifier A and one part identifier B. These substrates are distinguishable from a third substrate containing two parts identifier A and four parts identifier B or four parts identifier A and two parts identifier B. These substrates are also distinguishable from a fourth substrate containing no part A and four parts B. (i.e., only one identifier is used). This is further described in U.S. Pat. No. 6,838,289, incorporated herein by reference. Coding a substrate with more than two identifiers, e.g., three or more, will increase the number of uniquely identifiable substrates.

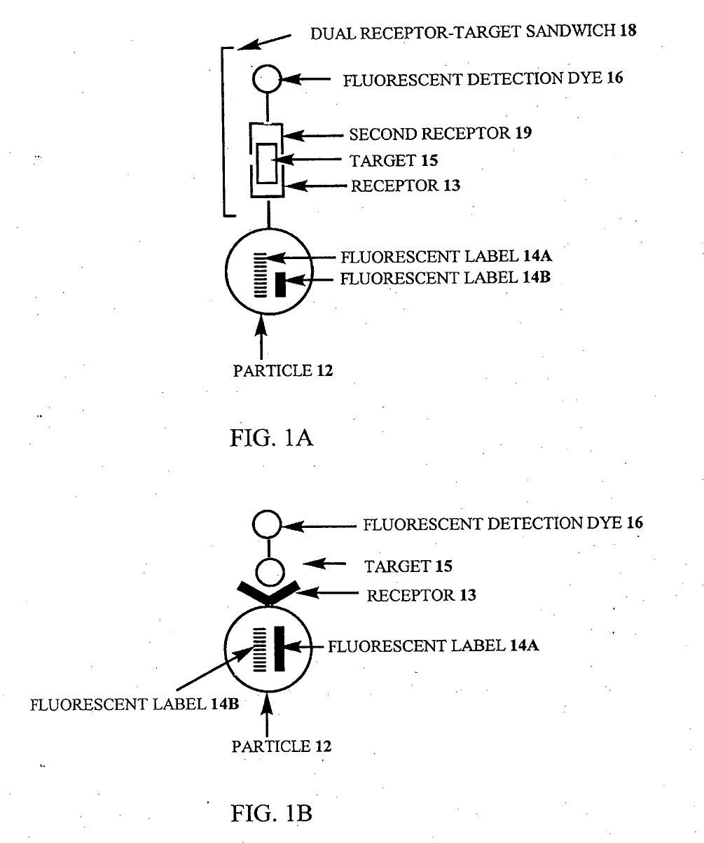

Exemplary substrates/particles for use in a multi-target detection system are shown in FIG. 1. As illustrated in FIG. 1, particle 12 is labeled with a fluorescent labels 14A, 14B and a target receptor 13 is attached to the particle 12. The particle containing the target receptor 13 is then used to assay a particular sample for a target 15 of interest. A fluorescent target detection dye 16 is also present. The target detection dye 16 emits a fluorescent signal when the target specific to the receptor is also present in the sample.

The fluorescent target detection dye can be a single fluorescer or a donor-receptor dye pair that is activated by energy transfer in the detection system, and can be synthetic or a naturally occurring fluorescein. Preferred dye structures which may be used to indicate complexing or reaction with a target of interest include the cyanine dyes known under the designations Cy5, dibenzoCy5, Cy7 and dibenzoCy7, as well as Nile Blue derivatives such as ETH 5294.

The fluorescent target detection dyes are complexed to the particle by various methods known to those skilled in the art depending on the particular assay employed in a specific analytical reaction. For example, the fluorescent target detection dye 16 can be attached to a receptor (not shown), or to a target 15 (FIG. 1B), or the target can contain a naturally occurring fluorochrome (not shown). The fluorescent target detection dye can also be attached to a second receptor in a dual receptor-target complex, (e.g., a “sandwich”), as exemplified in FIG. 1A.

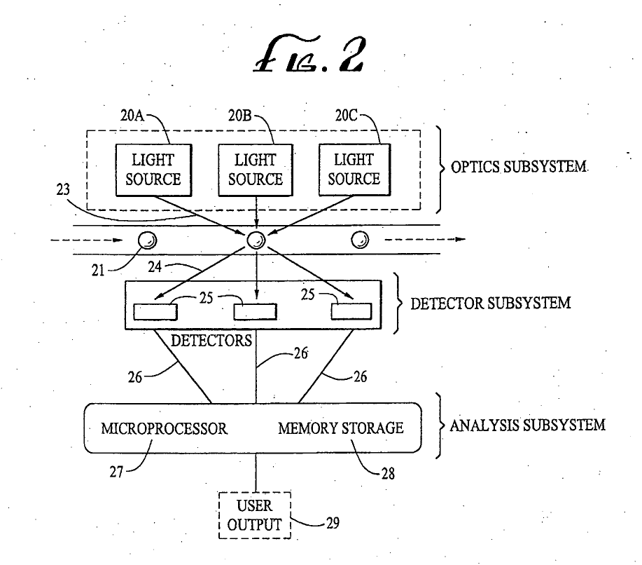

FIG. 2 is an exemplary schematic illustration of a system that can be used in the present invention when the identifiers are fluorescent labels. Light energy 23 is provided in a flow cytometer by exciting light sources 20A, 20B and 20C, such as a laser or an arc lamp, in an optics subsystem. Preferably, a longer wavelength excitation laser is used to simultaneously excite the fluorescent labels, used to mark substrates 21, and one or more shorter wavelength excitation lasers are used to excite the fluorescent target detection dyes. The optics subsystem of the cytometry device can include appropriate laser line filters, beam expanders, mirrors, lenses, and flowcells, as well as other components advantageous in operating a cytometry device.

Appropriate detectors 25 for detecting a particular emitting light 24 in a detector subsystem are used. The detectors 25 can be photodiodes or photomultipliers or similar devices that convert light signals into electrical impulses, thereby associating the detected signal with its fluorescent source. Detectors for detecting forward and side scattered light are known to those in the art and can be used to detect light scatter in the detection system. Light scatter and fluorescence can be simultaneously detected with respect to each particle in an examination zone. In a preferred, but not required, aspect of the invention, a forward scatter detector, a side scatter detector, and photomultiplier tubes are employed in the detection subsystem. The detector subsystem can also employ a system of filters, mirrors, as well as other components advantageous in operating a cytometry device. Electrical signals 26 from the detectors 25 are typically fed into the electronics of the system for signal and display processing, storage, and/or further processing.

In an analysis subsystem, hardware, such as a microprocessor 27 in combination with memory storage 28, such as a hard drive in a computer, collects detected data and processes the data. Analysis system software, used for data and signal processing, correlates detected data with known data to produce analytical results. The analysis subsystem collects data from the electrical signals associated with each particle.

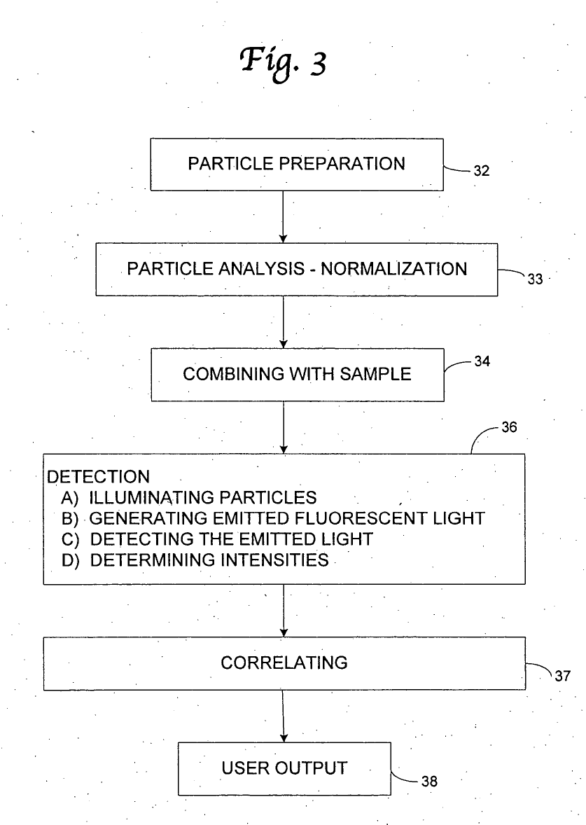

With reference to FIG. 3, a method according to the present invention generally comprises a particle preparation phase 32 in which various subpopulations of particles are prepared and coded as described above, and the detector particles are modified for target capture as described above. A portion of the particles are then analyzed to provide normalized data in a particle analysis phase 33. The particles are combined and exposed to an analytical sample and any appropriate reagents in phase 34. The particles are then analyzed and assigned to particular subsets according to predetermined classifications in a detection phase 36. Measurements relating to each set analyte are accumulated, the accumulated data is processed and interpreted in a correlation phase 37, and the interpreted results are given as output 38 to a user.

In the correlation phase 37, clusters of particles with similar fluorescence and forward and side scatter measurements are associated with analyte specificity by reference to the baseline fluorescence and scatter measurements made in the particle analysis phase 33.

Additional information regarding detection systems for detecting multiple targets simultaneously can be found in U.S. Pat. No. 6,838,289, incorporated herein by this reference.

More specifically, with reference to FIG. 3, the following steps can occur.

1. In the particle preparation phase 32, a detection system suitable for the targets to be detected is selected. The detection system has at least two detector substrates and at least one control substrate, and the detector substrates have at least one different identifier associated therewith. Appropriate chemistry is performed on each detector substrate and control substrate so each substrate is encoded with identifiers is chosen so that it is possible during the detection step to distinguish one set of substrates from each other. Because of the importance of the control substrate, which will become apparent from the example herein, it is desirable that the intensity of the detectable signal generated by the identifiers in the control substrates not be substantially greater nor substantially less than the signal from the detector substrates. It is preferred that the intensity of the signal for the identifier in a control substrate be greater than the intensity from at least one set of detector substrates and more preferably, greater than the intensity of the signal from all the sets of detector substrates. The same is true for the second identifier, and any additional identifiers that may be present in the system. Appropriate chemistry is also performed on each detector substrate so the detector substrate is appropriately adapted for capturing a target.

2. Next, in the particle analysis phase 33, the detector substrates and the control substrates are analyzed on a detection instrument, where the detector substrates and the control substrates are caused to produce detectable signals and the intensity of the produced detectable signals is determined. The detector substrates are then “normalized”, i.e., the relative ratio of the intensity of the actual signals from the detector substrates to the intensity of actual signals from the control substrates is determined. This can be conducted without any sample being present or with a standardized sample.

The detector substrates are “normalized” by automatically associating the detector substrates with their target/analyte. This is done by assigning a “relative ratio” factor to each detector substrate.

The “relative ratio” factor is obtained by dividing the intensity for a given detector substrate by the intensity of a control substrate for each identifier. The relative ratio for each detector substrate is represented by the formula:
Rᵢⱼ=I_{Nij}/C_{Nj}

Where:

Rᵢⱼ=the relative ratio factor for the detector substrate i, and identifier j;

I_{Nij}=the measured intensity of the signal from the detector substrate i, for identifier j; in the normalization step N; and

C_{Nj}=measured intensity of the signal from the control substrate for identifier j, in the normalization step N.

The normalized data for each detector substrate can be collected for multiple units and averaged. This data can be provided as media to a detection system user. The media can be provided as hard copy data, or as data in electronic form, which can be downloaded by a user into a particular analysis instrument.

3. In combining phase 34, the detection system is used by contacting a sample with the detector substrates for capturing targets. The incubation period of contact is sufficiently long to achieve the purpose of the assay. For example, if the assay is being conducted only to determine whether or not a particular target present in the sample, the incubation period can be shorter than if it is desired to determine the actual concentration of the target in the sample.

4. In the detection phase 36, the detector substrates and the control substrates are caused to produce detectable signals, and the intensity of the produced detectable signals is determined. For example, in a flow cytometer, the beads are “activated” with incoming laser light with a result that fluorescent labels present emit detectable light, which is detected.

5. In the correlation phase 37, the present invention improves on prior techniques with regard to how the detected signals are associated with the different sets of detector substrates. In particular, the expected signal intensities are calculated by multiplying the relative ratios calculated in phase 33 by the measured signal intensity for the control substrate determined in the detection phase 36.

For example, for a particular label:
I_{Eij}=Cⱼ*Rᵢⱼ

where

I_{Eij}=expected signal intensity for the detector substrate i, for identifier j;

Cⱼ=measured intensity of signal produced from the control substrate in the detection phase 36, for identifier j; and

Rᵢⱼ=is the relative ratio factor determined in the particle analysis phase 33.

Then, the actual signal intensities determined in the detection phase 36 are then compared with the calculated expected signal intensities for the detector substrates. Through these comparisons, it is possible to associate at least some of the produced signals with the appropriate detector substrates. This method also allows for the elimination of spurious signals from the test results. For example, the detection system can contain substrates that are not associated with any of the sets, and thus it is expected that in the correlation phase 36, there is no match with any of the sets of detector substrates. Thus, signals from unassociated substrates can be identified and not used in the analysis.

After the produced signals are associated with the appropriate detector substrates, the level of analytical signal for each detector substrate is determined. Additional calculations to determine, for example, analyte concentration for each detector substrate can then be performed.

6. In an output phase 38, a report can be produced, including, for example, the analyte type and analyte concentration information.

The present invention also comprises a kit. Such a kit comprises (a) the above-identified detection system comprising (i) at least two sets of detector substrates, and (ii) control substrates; and (b) media providing the normalization data obtained in the particle analysis phase 33. Optionally, the kit contains instructions for performing the assay. The media can be simply a sheet of paper, bar codes, a computer disc, or any other media for storing digital data such as a DVD, CD or thumb drive. Optionally, the data can be submitted through the Internet.

The kit can be provided with all the substrates mixed together, or different sets of substrates separate, with and without the control substrates mixed in with the detector substrates.

### EXAMPLE 1

Substrate Preparation.

A population of beads comprising twelve sets of beads was created by incorporating two different fluorescent labels in varying amounts into 12 different substrates. Each bead set, i.e., different detector substrates and a control substrate was coded by varying the loading of the dyes in the beads.

The beads were prepared by utilizing a shrink-swell method, described by L. B. Bangs (Uniform Latex Particles; Seragen Diagnostics Inc. 1984, p. 40), incorporated herein by reference, to incorporate two different fluorescent labels into carboxylated, cross-linked polystyrene beads (5.50 micrometers in diameter), obtained from Bangs Laboratories Inc. (Fishers, Ind.). The swell-shrink process consists of adding an oil-soluble or hydrophobic dye to stirred particles and after an incubation period, any dye that has not been absorbed by the particles is washed away. This process is also described in U.S. Pat. No. 6,838,289. The two dyes were bead code dye 1 (BCD1) (1,3-Bis[4-(dibutylamino)phenyl]-2,4-dihydroxycyclobutenediylium Dihydroxide, bis[inner salt]) and bead code dye 2 (BCD2), which is IR676 obtained from Aldrich Chemical located in (Milwaukee, Wis.). BCD1 has a peak emission at 675 nm and BCD2 has a peak emission at 715 nm.

Bead sets 1-11 were modified to capture the target analyte shown below in Table 1. Bead set 12 was not modified to capture a target analyte. Coupling of proteins to capture these targets were made using common procedures such as that given in Bangs Laboratories Technical Note 205, Rev. 003.

TABLE 1

| Bead Set | Target Analyte |
|---|---|
| 1 | IL-2 (Interleukin-2) |
| 2 | IL-6 (Interleukin-6) |
| 3 | IL-1 (Interleukin-1 |
| 4 | IL-12 (Interleukin-12) |
| 5 | TNF (Tumor Necrosis Factor) |
| 6 | FGF (Fibroblast Growth Factor) |
| 7 | IL-10 (Interleukin-10) |
| 8 | IL-4 (Interleukin-4) |
| 9 | IL-8 (Interleukin-8) |
| 10 | GM-CSF (Granulocyte-Macrophage Colony Stimulating |
| | Factor) |
| 11 | VEGF (Vascular Endothelial Growth Factor) |

### EXAMPLE 2

Substrate Normalization.

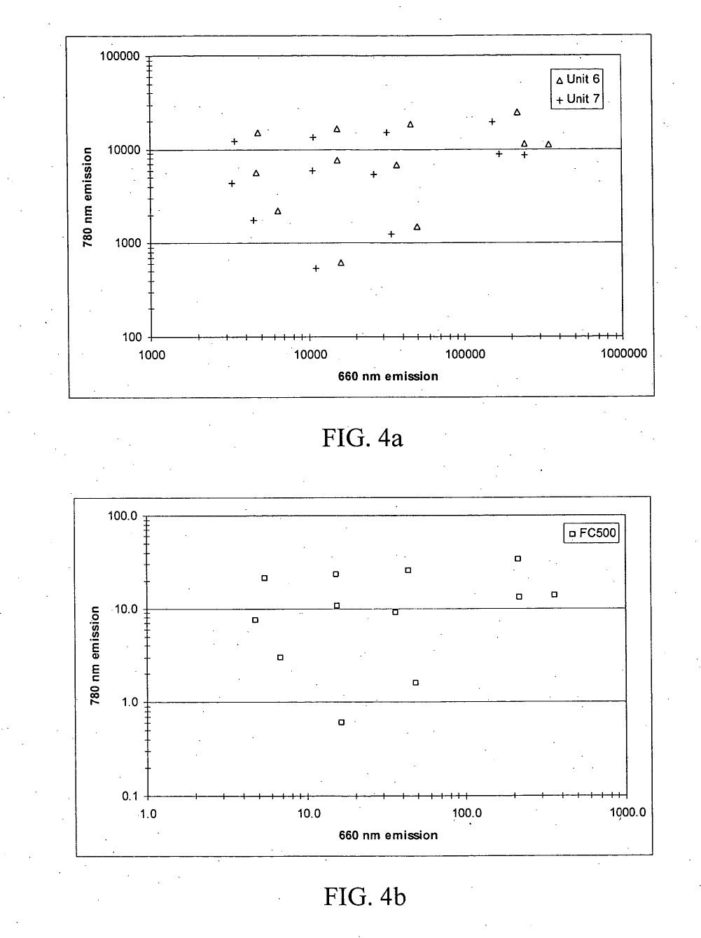

The intensity of produced detectable signal for each bead set was determined with two research flow cytometer units (“Unit 6” and “Unit 7”) and a commercially available FC500 unit, available from Beckman Coulter (Fullerton, Calif.). These systems each contain two lasers, a 488 nm laser and a 635 nm laser and measure forward scatter and side scatter. The systems also contain three photomultiplier tubes (PMT) to acquire fluorescent emission and also have bandpass filters in front of each PMT which allow light from 525 nm, 660 n, and 780 nm to reach the detector. Comparable commercially available systems to the Unit 6 and Unit 7 systems include the FC500 and EPICS ALTRA systems from Beckman Coulter (Fullerton, Calif.). FIG. 4a is a plot average measured intensities for 12 substrate populations from the two different cytometer units (Unit 6 and Unit 7), in two different coding channels (660 nm and 780 nm). FIG. 4b is a plot of the average measured intensities for 12 substrate populations from the commercially available FC500 unit in two different coding channels (660 nm and 780 nm). FIGS. 4a and 4b demonstrate the variances resulting from the particular instrument used. Because of the variance, it is difficult to associate the results with any particular bead set.

The normalized results, or the “relative ratio” factor for each detector substrate was calculated in the two different coding channels. The bead populations were normalized based on the values measured on bead set 12, which was used as the control. Bead set 12 was arbitrarily given a value of “1”, and the values for the other beads presented in the table are presented as the ratio of the measured intensity for each set versus the measured intensity for bead set 12. The calculated relative ratio factor for each detector substrate, for each coding channel is presented in Tables 2 and 3. Table 4 lists the average relative ratio factor from the three different cytometers and assigned analyte.

TABLE 2
Normalized Data for BCD1 collected at 660 nm

| Set | FC500 | Unit 6 | Unit 7 | Average | % RSD |
|---|---|---|---|---|---|
| 1 | 0.032 | 0.029 | 0.030 | 0.030 | 4.4 |
| 2 | 0.022 | 0.021 | 0.022 | 0.022 | 2.3 |
| 3 | 0.076 | 0.074 | 0.074 | 0.074 | 1.6 |
| 4 | 0.026 | 0.022 | 0.023 | 0.023 | 7.9 |
| 5 | 0.072 | 0.070 | 0.070 | 0.071 | 2.1 |
| 6 | 0.223 | 0.227 | 0.223 | 0.224 | 1.0 |
| 7 | 0.071 | 0.070 | 0.071 | 0.071 | 0.7 |
| 8 | 0.169 | 0.170 | 0.174 | 0.171 | 1.4 |
| 9 | 0.204 | 0.208 | 0.213 | 0.208 | 2.1 |
| 10 | 1.020 | 1.111 | 1.104 | 1.078 | 4.7 |
| 11 | 1.692 | 1.576 | 1.590 | 1.619 | 3.9 |

TABLE 3
Normalized Data BCD2 collected at 780 nm

| Set | FC500 | Unit 6 | Unit 7 | Average | % RSD |
|---|---|---|---|---|---|
| 1 | 0.089 | 0.090 | 0.090 | 0.090 | 0.4 |
| 2 | 0.226 | 0.228 | 0.225 | 0.226 | 0.5 |
| 3 | 0.018 | 0.025 | 0.027 | 0.023 | 21.1 |
| 4 | 0.640 | 0.610 | 0.617 | 0.622 | 2.5 |
| 5 | 0.315 | 0.310 | 0.305 | 0.310 | 1.8 |
| 6 | 0.048 | 0.061 | 0.063 | 0.057 | 14.5 |
| 7 | 0.693 | 0.674 | 0.692 | 0.686 | 1.6 |
| 8 | 0.271 | 0.275 | 0.276 | 0.274 | 1.1 |
| 9 | 0.762 | 0.753 | 0.774 | 0.763 | 1.4 |
| 10 | 0.390 | 0.457 | 0.445 | 0.431 | 8.3 |
| 11 | 0.411 | 0.450 | 0.445 | 0.435 | 4.9 |

Units refer to a particular cytometer unit.

RSD=relative standard deviation

TABLE 4
Average Normalized Data Values from Tables 2 and 3

| Set | BCD1, 660 nm | BCD2, 780 nm | Target |
|---|---|---|---|
| 1 | 0.030 | 0.090 | IL-1 |
| 2 | 0.022 | 0.226 | IL-2 |
| 3 | 0.074 | 0.023 | IL-5 |
| 4 | 0.023 | 0.622 | IL-6 |
| 5 | 0.071 | 0.310 | IL-8 |
| 6 | 0.224 | 0.057 | IL-12 |
| 7 | 0.071 | 0.686 | VEGF |
| 8 | 0.171 | 0.274 | INF |
| 9 | 0.208 | 0.763 | IFN |
| 10 | 1.078 | 0.431 | FGF |
| 11 | 1.619 | 0.435 | GM-CSF |

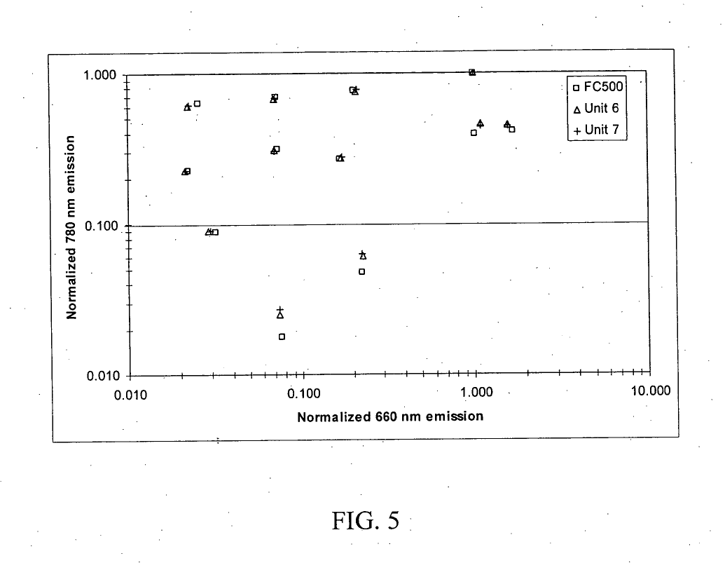

FIG. 5 shows the data as in Table 4, normalized and plotted, using the average relative ratios of the detector substrates and the bead set 12 as the control. This demonstrates that this technique reduces the perceived variance resulting from different instrumentation, thus making it much easier to associate the intensity data with a particular bead set.

Another device suitable for processing the substrates after contact with the sample is described in U.S. Patent Publication No. 2004/0096977, which is incorporated herein by reference. This device comprises a processor having a body, a process section in the body, and a feed stream inlet conduit and a feed stream outlet conduit into and out of the process section, respectively. The process section comprises positioning means for positioning the particles in the process section so the particles do not overlap. The position means can be a plurality of pockets that are sized to receive only one particle. The device can be used instead of a flow cytometer.

Although the present invention has been described in considerable detail with reference to certain preferred version thereof, other versions are possible. For example, the control beads can be used during the step of contacting the sample, or optionally never contact a sample. Therefore, the spirit and scope of the appended claims should not necessarily be limited to the description of the preferred versions contained herein.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means” for “step” clause as specified in 35 U.S.C. § 112.

What is claimed is:

1. A method for detecting a plurality of different targets in a sample comprising:
a) selecting a detection system comprising at least first and second detector substrates and at least one control substrate, wherein
each detector and control substrate has at least one identifier associated therewith, the identifier being capable of producing a detectable signal for each detector and control substrate, respectively, and
the detectable signal for each detector substrate and control substrate is different; and wherein
the first detector substrate is adapted for capturing a first selected target in the sample, and the second detector substrate is adapted for capturing a second selected target in the sample, the first and second selected targets being different;
b) causing the detector substrates and the control substrate to produce detectable signals and determining the intensity of the produced detectable signals;
c) ascertaining the ratio of detectable signals from the detector substrates to the control substrate to produce a relative ratio for each detector substrate;
d) contacting the sample with the first and second detector substrates for capturing targets;
e) after step (d), causing the detector substrates and the control substrate to produce first and second detectable signals and determining the intensity of the produced detectable signals;
f) ascertaining expected detectable signal intensities for each set of the detector substrates based on the determined intensity of the produced detectable signal of the control substrate from step (e) and the relative ratio for each detector substrate from step (c);
g) comparing the determined intensities of the detector substrates from step (e) with the expected detectable signal intensities from step (f) to associate at least some of the produced detectable signals of step (e) with respective sets of the detector substrates.

2. The method of claim 1 wherein step (d) comprises contacting the sample with unassociated substrates not part of any of the sets, and wherein some of the detectable signals produced in step (e) are from the unassociated substrates, and the step (g) of comparing comprises identifying signals as being produced from the unassociated substrates.

3. The method of claim 1 wherein steps (f) and (g) are performed on a computer.

4. The method of claim 1 including the step of contacting the sample with the control substrate.

5. The method of claim 4 wherein step (d) includes the step of contacting the sample with the control substrate.

6. The method of claim 1 wherein the control substrate is a detector substrate.

7. The method of claim 1 wherein the control substrate is different from each of the detector substrates.

8. The method of claim 7 wherein the control substrate is substantially incapable of capturing any target present in the sample.

9. The method of claim 1 wherein the identifiers are fluorescent labels.

10. The method of claim 9 wherein the fluorescent dyes have a near infrared fluorescence.

11. The method of claim 1 wherein at least one detector or at least one control substrate has at least two identifiers associated therewith, each identifier being different.

12. The method of claim 11 wherein each detector and control substrate has first and second identifiers associated therewith, the first and second identifiers being capable of producing a set of first and second detectable signals for each detector and control substrate, respectively, wherein the first and second detectable signals are different, and the intensity of the set of first and second detectable signals from each detector substrate and control substrate differ from each other.

13. The method of claim 1 wherein at least one of the detector substrates or at least one of the control substrates have more than two identifiers associated therewith.

14. The method of claim 1 wherein at least one of the detector substrates is adapted for capturing a target in the sample, the target having a detection dye associated therewith, and including the step of causing the detection dye to produce a detectable signal.

15. The method of claim 14 further including detecting the detectable signal from the detection dye and associating the detection dye with the target.

16. The method of claim 1 wherein the substrates are beads.

17. The method of claim 1 wherein the substrates are beads and at least one of steps (b) or (e) is performed with a multiple well plate or flow cytometer.

18. A system for detecting multiple different targets in a sample comprising:
at least first and second detector substrates and at least one control substrate,
each substrate having first and second identifiers associated therewith,
the first and second identifiers being capable of producing first and second detectable signals, respectively,
the first and second detectable signals being different,
wherein the first detector substrate is capable of capturing a first selected target in the sample, the second detector substrate is capable of capturing a second selected target in the sample, the first and second selected targets being different, and
wherein the intensity of the detectable signals from each detector substrate and from the control substrate differ from each other for at least one of the detectable signals.

19. A kit for assaying multiple different targets in a sample comprising:
a) a detection system comprising at least first and second detector substrates and at least one control substrate, wherein
each detector and control substrate has at least one identifier associated therewith, the identifier being capable of producing a detectable signal for each detector and control substrate, respectively, and
the detectable signal for each detector substrate is different; and wherein
the first detector substrate is adapted for capturing a first selected target in the sample, and the second detector substrate is adapted for capturing a second selected target in the sample, the first and second selected targets being different; and
b) media providing data for calculating expected detectable signal intensities for each set of the detector substrates based on a determined intensity of the detectable signals from the control substrates.

20. The kit of claim 19 wherein the control substrate is the same as one of the detector substrates.

21. The kit of claim 19 wherein the control substrate is different from each of the detector substrates.

22. The kit of claim 21 wherein the control substrate is substantially incapable of capturing any target present in the sample.

23. The kit of claim 19 wherein each detector and control substrate has first and second identifiers associated therewith, the first and second identifiers being capable of producing a set of first and second detectable signals for each detector and control substrate, respectively, wherein the first and second detectable signals are different, and the intensity of the set of first and second detectable signals from each detector substrate and control substrate differ from each other.

24. The kit of claim 19 comprising instructions for performing the assay.

25. The kit of claim 24 wherein the instructions for performing the assay comprise instructions for the steps of:
i) contacting the sample with the detector substrates for capturing selected targets;
ii) after step (i), causing the detector substrates and the control substrate to produce the first and second detectable signals and determining the intensity of the detectable signals;
iii) ascertaining expected detectable signal intensities for each set of the detector substrates based on the determined intensity of the detectable signals of the control substrate from step (ii) and the data provided in the kit; and
iv) comparing the determined intensities of the detector substrates from step (ii) with the expected detectable signal intensities of from step (iii) to associate at least some of the detectable signals of step (ii) with respective sets of the detector substrates.

26. The invention of claim 1, 18, or 19 wherein the substrates are beads, and the control substrates are at least 10% larger or at least 10% smaller in diameter than the detector substrates.
